(19) United States
(12) Patent Application Publication
(10) Pub. No.: US 2024/0351012 A1
(43) Pub. Date: Oct. 24, 2024

(54) CATALYTIC COPOLYMER COMPOSITION

(71) Applicant: MACFARLAN SMITH LIMITED, WAYNE, PA (US)

(72) Inventor: Stephen Johnson, Wayne, PA (US)

(21) Appl. No.: 18/640,634

(22) Filed: Apr. 19, 2024

Related U.S. Application Data
(60) Provisional application No. 63/497,014, filed on Apr. 19, 2023.

(51) Int. Cl. B01J 35/30; B01J 31/16

(52) U.S. Cl. CPC B01J 35/398; B01J 31/165; B01J 2531/824

(57) ABSTRACT

A catalytic composition comprising a transition metal catalyst entrapped within a monounsaturated vinyl aromatic/polyunsaturated vinyl aromatic copolymer, such as a styrene-divinyl benzene copolymer, matrix. In addition, processes for decomposing organic materials in a highly alkaline environment, and for conducting organic coupling reactions employing such catalyst compositions are disclosed.

### FIELD OF THE INVENTION

In one aspect, the present invention is directed a catalytic composition comprising a transition metal catalyst entrapped within a monounsaturated vinyl aromatic/polyunsaturated vinyl aromatic copolymer matrix, such as a styrene-divinylbenzene copolymer matrix. In other aspects, the present invention is directed to processes for decomposing organic materials in a highly alkaline environment, as well as for conducting organic coupling reactions employing such catalytic composition.

### BACKGROUND OF THE INVENTION

One of the most pressing and challenging issues currently faced in environmental remediation is the treatment of organic contaminants present in highly alkaline aqueous environments. In particular, severe risks to the environment exist in connection with the organic components of the highly alkaline wastes associated with nuclear energy and weapons production.

Thus, for example, the U.S. Department of Energy's site in Hanford, Washington, is the storage facility for radioactive waste resulting from the production of plutonium for nuclear weapons. The site contains 177 single wall underground storage tanks and 28 newer double-walled tanks containing in excess of 50 million gallons of toxic nuclear waste. The content of many of these tanks is extremely alkaline, with several having a pH estimated to be higher than 14 (Wells et al; Hanford Waste Physical and Rheological Properties: Data and Gaps; PNNL-20646 EMSP-RPT-006; Pacific Northwest National Laboratory; August 2011). This highly alkaline waste can generate heat with the result that corrosion of the steel storage tanks occurs. According to the Department of Energy's web page, Cleanup Progress at Hanford, June 2016, as many as 67 of the single walled tanks are believed to have leaked. Although the double-walled tanks are presumed safer, the inner wall of at least one such tank has leaked, the probable cause of which was concluded to be “corrosion at high temperatures in a tank whose waste containment margins had been reduced by construction difficulties” (Washenfelder, Forensic Investigation of Hanford Double-Shell Tank AY-102 Radioactive Waste Leak—14178; WM 2014 Conference, Mar. 2-6, 2014, Phoenix, AZ, USA). More recently, there is a concern that a second double-walled tank AY 101 was also leaking (AP, Hanford may have another underground tank leaking radioactive waste, DOE says, Apr. 26, 2016).

In addition to containing radioactive heavy metals (including Sr-90 (⁹⁰Sr), which is insoluble and associated with tank waste sludge; and Cs-137 (¹³⁷Cs), which is soluble and found in tank supernatant) such waste contains volatile organic compounds (VOCs), including nitrosamines, as well as quantities of combustible gases such as H₂ as a result of radiolysis of such VOCs. These compounds create environmental concerns in the event of leakage and may result in the buildup of pressure in sealed tanks, creating a risk of potential explosions or explosive release. Consequently, there is a need for a means to degrade such VOCs in such a high alkaline environment.

It is known that these organic contaminants may be reduced to less harmful and/or less volatile compounds employing precious metal (such as Pd or Pt) catalysts, although the use of other cheaper metal catalysts has also been explored. See, for example, the disclosure in Frierdich et al, Rapid Reduction of N-Nitrosamine Disinfection Byproducts in Water with Hydrogen and Porous Nickel Catalysts, Environmental Science & Technology, Vol. 42, No. 1, February 2008, pp. 262-269.

However, there are two considerations which must be taken into account before a catalyst can be effectively employed to degrade organic materials in high alkaline environments which may possess a pH in excess of 14: (1) the catalyst must be associated with a support which will itself be stable in such an extreme environment; and (2) the catalyst must be bound or otherwise associated with the support in a manner which prevents excessive leaching or loss of the catalyst from the support.

In this regard, it is noted that while catalysts supported on an organic resin are suitable for wastewater treatment, most organic resins are not suitable for use in highly alkaline nuclear waste streams. Thus, as is noted in EPA Grant Number R828598C026, Use of Inorganic Ion Exchanges for Hazardous Waste Remediation, Ho, 2000; while materials such as organic ion exchange resins find extensive use in variety of industrial processes, commercially available resins are unusable for use in hostile environments such as nuclear waste streams, as such resins are not stable in such environments.

Even if a support which itself can withstand a high alkaline environment is employed, the catalyst itself must be secured to the support such that excessive leaching of the catalyst does not occur—this later requirement is of great concern in highly alkaline waste, as the alkaline environment will destroy many ionic, hydrogen or even covalent bonds.

Thus, while certain monounsaturated vinyl aromatic/polyunsaturated vinyl aromatic copolymer resins will be able to remain stable in highly alkaline environments, current catalyst systems based upon such resins may not be effective due to cleavage of the bonds linking the catalyst metal to such resins, with the result that extensive leaching may occur. Thus, for example, Kirk et al (U.S. Pat. No. 6,743,873) and Lundquist et al (U.S. Pat. No. 6,982,307) describe styrene/divinylbenzene (PS/DVB) resins having Ziegler-Natta catalysts bound covalently thereto via epoxy and free olefin groups, respectively. While such catalysts function well under conditions suitable for Ziegler-Natta catalysis, under extreme alkaline conditions such as those present in nuclear waste materials, unduc leaching of the metal catalyst may occur due to the degradation of the bonds holding the catalyst to the polymer matrix.

Somewhat similarly, Gomann et al, Palladium-mediated organic synthesis using polymer monolith formed in situ as a continuous support structure for application in microfluidic devices; Tetrahedron 65 (2009); 1450-55 disclose the use of monolithic catalyst compositions prepared by first forming a monolithic structure by reacting chloromethylstyrene and divinylbenzene; modifying such monolithic structure by reaction with a ligand which reacts with the chorine moiety (1-methylimidazole or 5-amino-1,10-phenanthroline); and reacting said palladium compound with a catalytic palladium compound (PdCl₂(NCMe)₂) to conduct Suzuki-Miyura and Sonogashira couplings. Pertinently, Gomann et al stresses that the presence of such ligands to chemically bond the palladium catalyst to the pre-formed matrix is critical, stating (at page 1451) that “Capillaries that were not functionalized with ligands, but were subjected to passage of PdCl₂(NCMe)₂ as described above, were inactive in catalysis.”

Accordingly, it is unexpected that catalyst compositions in which the catalyst is physically entrapped within a monounsaturated vinyl aromatic/polyunsaturated vinyl aromatic copolymer matrix without the requirement of being bound to a ligand such as 1-methylimidazole or 5-amino-1,10-phenanthroline would be effective to conduct Suzuki-Miyura, Sonogashira and similar coupling reactions; much less that such catalyst compositions could be effectively employed to treat contaminants or other materials in more extreme environments, such as the highly alkaline environments present in certain nuclear waste storage facilities.

### SUMMARY OF THE INVENTION

In one aspect, the present invention is directed to a catalyst composition comprising a transition metal catalyst entrapped within a monounsaturated vinyl aromatic/polyunsaturated vinyl aromatic copolymer matrix.

In another aspect, the present invention is directed to a method of decomposing organic materials contained in highly alkaline environments, such as nuclear waste materials, which process comprises contacting said organic materials with such catalyst composition.

In yet another aspect, the present invention is directed to a method of conducting an organic coupling reaction, such as a Heck-Mirozoki, Suzuki-Miyaura, Sonogashira-Hagihara, Kumada-Corriu or Negishi reaction employing such catalyst composition.

### DETAILED DESCRIPTION OF THE INVENTION

In one aspect, the present invention is directed to a catalyst composition comprising a transition metal catalyst entrapped within a monounsaturated vinyl aromatic/polyunsaturated vinyl aromatic copolymer matrix.

As is employed herein, the term “entrapped” means that the catalyst is located within a polymeric matrix, and is primarily sequestered within such matrix by physical or steric hindrance rather than by chemical, covalent, ionic and/or H-bonding forces. In this regard, such catalyst may be “encapsulated” as a result of a suspension polymerization process; or “microencapsulated” as the result of an emulsion polymerization process.

The entrapped catalysts employed is the practice of this invention include metals and metal complexes thereof, such as those based upon platinum, palladium, osmium, ruthenium, rhodium, iridium, rhenium, scandium, cerium, samarium, yttrium, ytterbium, lutetium, cobalt, titanium, chromium, copper, iron, nickel, manganese, tin, mercury, silver, gold, zinc, vanadium, tungsten and molybdenum. Typically, for many coupling reactions a platinum metal catalyst (most typically a palladium catalyst) is employed.

The specific catalysts which may be employed are typically well known to those of skill in the art, and are summarized in review articles such as M. Piquet's review of Organometallic as Catalysts in the Fine Chemical Industry, Platinum Metals Rev., 57, (4) 272-280 (2013) and Farina, High-Turnover Palladium Catalysts in Cross-Coupling and Heck Chemistry: A Critical Overview, Adv. Synth. Catal. 2004, 346, 1553-1582; as well as in the patent literature (see U.S. Pat. No. 8,828,902 to Ramarao et al)—which documents are herein incorporated by reference.

Illustrative of such catalysts are rhodium catalysts such as Rh(CO)₂(acac), Rh₂(2-ethylhexanoate)₄ , Rh-PPh₃, Knowles' Rh(dipamp)(COD)[BF₄] catalyst, Rh(eniphos)(nbd)[PF₆], [Rh(duanphos)(NBD)][SbF₆], [Rh(NBD)₂][BF₄]/Walphos or [Rh(COD)₂][BF₄]/phosphoramidite/(m-Tol) ₃P mixtures, and [Rh(Cp*)Cl₂]₂; ruthenium catalysts such as [Ru(Binap)(CF₃CO₂)₂], [Ru(MeO-biphep)(CF₃CO₂)₂], (Ru=[Ru(Tol-Binap)Cl₂]₂·NEt₃), [Ru(Tol-Binap)(p-cymene)I], [RuH(COD)(COT)][BF₄], and Ru(diphosphine)(diamine) systems; iridium catalysts such as [Ir(COD)Cl]₂ and the [Ir(COD)Cl]₂/(4-MeO-3,5-(tBu)₂C₆H₂)-MeO-Biphep couple; and palladium catalysts such as tris(dibenzylideneacetone) dipalladium(O) (Pd₂(dba)₃), palladium (II) chloride (PdCl₂), palladium(II) acetate (Pd(OAc)₂), (1,1′-bis(diphenylphosphino) ferrocene)palladium(II) chloride, dichlorobis(triphenylphosphine)palladium II) (PdCl₂(PPh₃)₂), Pd₂(dba)₃/PMe₃, and Pd(OAc)₂/PtBu₃.

Other catalysts which may be employed in the practice of this invention include those disclosed in Catalytic Asymmetric Synthesis 2nd Ed. Ed. I. Ojima Wiley-VCH including without limitation the list of chiral ligands included in the appendix thereof; Metal diphosphine catalysts such as those disclosed in EP 612758 Solvias RhJosiPhos, EP 366390 Takasago RuBINAP, EP 398132 Roche MeOBIPHEP, U.S. Pat. No. 5,008,457 DuPont DuPhos and PCT/GB99/03599 OxPhos; Metal phosphine catalysts such as Wilkinson's catalysts disclosed in Chem. Rev., 1991, 91, 1179; Metal phosphoramidate catalysts such as those disclosed in WO 02/04466 DSM MonoPhos; Metal aminophosphine catalysts such as those disclosed in A. Pfaltz Acc. Chem. Res. 1993, 26, 339, J. M. Brown, D. Hulmes, T. Layzell J. Chem. Soc. Chem. Commun. 22, 1673, 1993, and J. Am. Chem. Soc., 1992, 114, 9327; metal arylamine catalysts such as those disclosed in Organometallics, 1997, 16 (23), 4985-4994; metal diamine catalysts such as those disclosed in U.S. Pat. No. 5,663,393 Jacobsen epoxidation, U.S. Pat. No. 5,637,739 Jacobsen cpoxidation, U.S. Pat. No. 5,929,232 Jacobsen epoxide resolution, U.S. Pat. No. 4,871,855 Sharpless dihydroxylation, U.S. Pat. No. 5,260,461 Sharpless dihydroxylation, U.S. Pat. No. 5,767,304 Sharpless aminohydroxylation, U.S. Pat. No. 5,859,281 Sharpless aminohydroxylation, U.S. Pat. No. 6,008,376 Sharpless aminohydroxylation and WO 02/10095 for Catalytic Asymmetric Cyanohydrin; Metal aminoalcohol catalysts such as those disclosed in WO9842643 Zeneca CATHy, and EP0916637 ERATO Noyori CTH; Metal phosphate catalysts such as those disclosed in Cserepi-Szucs, S., Bakos, J. Chem. Soc. Chem. Commun. 1997, 635; metal salt catalysts such as salts of magnesium, aluminum, tin and iron for instance halide salts such as chlorides of magnesium, aluminum, tin and iron; metal alkoxide catalysts such as those disclosed in Verdaguer X., Lange, U. E. W., Reding, M. T., Buchwald S. L. J. Am. Chem. Soc. 1996, 118, 6784; metal arene catalysts such as those disclosed in U.S. Pat. No. 5,489,682 Buchwald hydrogenation, U.S. Pat. No. 5,929,266 Whitby hydrogenation; metal arene phosphine catalysts such as those disclosed in Ciruelos, S., Englert, E., Salzer, A., Bolm, C., Maischak, A. Organometallics 19, 2240, 2000; metal carbene catalysts for alkene metathesis such as those described in J. Am. Chem. Soc., 1994, 116, 3414, J. Am. Chem. Soc., 1999, 121, 2674 and J. Am. Chem. Soc. 1993, 115, 9856; and metallocycle catalysts such as those described in Angew. Chem. 1995, 34, 1844 and Chem. Commun. 1998, 2095.

Cluster catalysts may also be employed in the practice of this invention. Illustrative cluster catalysts include molybdenum-rhodium catalysts such as Mo₂RhCp₃(CO)₅; rhodium catalysts such as Rh₄(CO)₁₀₊ₓ(PPh₃)₂₋ₓ(x=0,2); ruthenium-osmium catalysts such as H₂RuOs₃(CO)₁₃; ruthenium-cobalt catalysts such as RuCo₂(CO)₁₁, Ru₂Co₂(CO)1₃ and HRuCo₃(CO)₁₂; iridium catalysts such as Ir₄(CO)₁₂; iron catalysts such as Fe₃(CO)₁₂; osmium-nickel catalysts such as H₃Os₃NiCp(CO)₉ and Os₃Ni₃Cp₃(CO)₉; nickel catalysts such as Ni₂+xCp₂+x(CO)₂ (x=0,1) and Ni₄(Me₃CNC)₇; vanadium-chromium catalysts such as VCrCp₃(CO)₃; iron-platinum catalyst such as Fe₂Pt(CO)₆(NO)₂(Me₃CNC)₂; ruthenium-iridium catalysts such as Rh₃+xIr₃₋ₓ(CO)₁₆(x=0,1,2); molybdenum-iron catalysts Mo₂Fc2S₂Cp₂(CO)₈ and ruthenium-nickel catalysts such as H₃Ru₃NiCp(CO)₉.

The copolymer matrix in which the transition metal catalyst is entrapped is produced from a mixture comprising (a) one or more monounsautated vinyl aromatic monomer; and (b) one or more polyunsaturated vinyl aromatic monomer.

Suitable polyvinylaromatic monomers that may be used include, for example, one or more monomer selected from the group consisting of divinylbenzene, 1,3,5-trivinylbenzene, divinyltoluene, divinylnaphthalene, and divinylxylene; it is understood that any of the various positional isomers of each of the aforementioned monomers is suitable; preferably the polyvinylaromatic monomer is divinylbenzene. Preferably the copolymer matrix comprises 2 to 95%, and more preferably 10 to 80%, by weight of polyvinyl aromatic monomer units, based upon the total weight of monomers present.

Suitable monounsaturated vinylaromatic monomers include, for example, styrene, α-methylstyrene, (C₁-C₄) alkyl-substituted styrenes and vinylnaphthalene; preferably one or more monounsaturated vinylaromatic monomer is selected from the group consisting of styrene and (C₁-C₄) alkyl-substituted styrenes. Included among the suitable (C₁-C₄) alkyl-substituted styrenes are, for example, ethylvinylbenzenes, vinyltoluenes, diethylstyrenes, ethylmethylstyrenes and dimethylstyrenes; it is understood that any of the various positional isomers of each of the aforementioned vinylaromatic monomers is suitable. Typically, the copolymer matrix comprises 5% to 98%, and more typically 20 to 90%, by weight of monounsaturated vinylaromatic monomer units, based upon the total weight of monomers present. Vinyl monounsaturated vinyl aromatic monomers substituted with crown ether, such as those described in U.S. Pat. Nos. 4,447,585; 4,650,846; and 4,478,983: the disclosures of which are hereby incorporated by reference, may also be employed.

In certain embodiments of the present invention, one or more non-aromatic polyunsaturated monomers may be added to the polymerization reaction mixture. As used herein, such non-aromatic polyunsaturated monomers may also be referred to as cross-linkers or graftlinkers. The term “cross-linker”, as used herein, refers to multi-functional monomers capable of forming two or more covalent bonds between polymer molecules of the same type. The term “graftlinker”, as used herein, refers to multi-functional monomers capable of forming two or more covalent bonds between polymer molecules of one type with polymer molecules of another type. Suitable non-aromatic polyunsaturated monomers include, for example, the ethylene glycol diacrylate, ethylene glycol divinylketone, divinylsulfide, allyl methacrylate, diallyl maleate, diallyl fumarate, diallyl succinate, diallyl carbonate, diallyl malonate, diallyl oxalate, diallyl adipate, diallyl sebacate, divinyl sebacate, diallyl tartrate, diallyl silicate, triallyl tricarballylate, triallyl aconitate, triallyl citrate, triallyl phosphate, N,N-methylene dimethacrylamide, N,N-methylene dimethacrylamide, N,N-ethylenediacrylamide, trivinylbenzene, and the polyvinyl ethers of glycol, glycerol, pentaerythritol, resorcinol, monothio and dithio derivatives of glycols, and combinations thereof Still further non-limiting examples of non-aromatic polyunsaturated monomers which may be employed include butylene glycol dimethacrylate, alkanepolyol-polyacrylates or alkane polyol-polymethacrylates such as ethylene glycol diacrylate, ethylene glycol dimethacrylate, butylene glycol diacrylate, oligoethylene glycol diacrylate, oligoethylene glycol dimeth-acrylate, trimethylolpropane diacrylate, trimethylolpropane dimeth-acrylate, trimethylol-propane triacrylate (“TMPTA”) or trimethylolpropane trimethacrylate, and unsaturated carboxylic acid allyl esters such as allyl acrylate, diallyl malcate, and typically allyl methacrylate, and the like. Additional, non-limiting examples of polyunsaturated monomers are provided in U.S. Pat. No. 4,582,859. Such nonaromatic unsaturated monomers typically comprise as polymerized units, from zero to 20%, more typically from zero to 10%, and even more typically from zero to 5% by weight of the copolymer matrix, based on the total monomer weight used to form the polymer matrix.

In other embodiments of the present invention, the monounsaturated vinyl aromatic monomer and polyunsaturated vinyl aromatic monomer are further co-polymerized with 0.01-30% by weight, typically of from 0.5-5% by weight, of a sulfonated cross-linking agent; or the copolymer matrix is cross-linked by reacting the copolymer with a cross-linking agent that forms sulfonated cross-linking bridges (e.g. sulfone bridges) in the copolymer. Sulfone cross-linked materials may be prepared by treatment with a sulfonating reagent mixture comprising either (1) a mixture of chlorosulfonic acid and sulfur trioxide or (2) a mixture of boron oxide or boric acid and one or more reagents selected from sulfuric acid, chlorosulfonic acid and sulfur trioxide, said sulfonating reagent mixture being used in excess of stoichiometric requirements as described in U.S. Pat. No. 4,177,331 (Amick), the disclosure of which is hereby incorporated by reference. Alternatively, such sulfone cross-linking may be achieved by reaction with a monomer mixture comprising a monovinyl aromatic monomer, a polyvinyl aromatic monomer, and a free-radical initiator as is described in U.S. Pat. No. 5,616,622 (Harris), the disclosure of which is also incorporated by reference.

Suitable polymers usefully employed for encapsulating catalysts include but are not limited to divinylbenzene copolymers, styrene divinylbenzene copolymers, styrene/divinylbenzene resins and cross-linked styrene/divinylbenzene polymers.

The loading level of the catalyst in the matrix can vary greatly, with ranges of 0.01 mmol/g to 0.6 mmol/g of catalyst being typically present based on the metal content in the catalyst. More typically, catalyst loadings of 0.2 mmol/g to 0.4 mmol/g are present.

The catalyst compositions of this invention are typically prepared by suspension, solution or emulsion polymerization and preferably possess a surface area greater than 1 m²/g, preferably greater than 10 m²/g and more preferably greater than 100 m²/g. Preferably porosity is introduced into the copolymer beads by suspension-polymerization in the presence of a porogen (also known as “phase extender” or “precipitant”), that is, a solvent for the monomer but a non- solvent for the polymer. Preferably, such porogen also serves as a solvent or dispersant medium for the catalyst. Typically, the transition metal catalyst is suspended in the solvent/porogen, and monounsautated vinyl aromatic monomers and polyunsaturated vinyl aromatic monomers added. Polymerization is the initiated employing a free radical initiator.

A typical macroporous (or macroreticular) polymer bead preparation is described in U.S. Pat. No. 6,982,307 the disclosure of which is hereby incorporated by reference. This may include, for example, preparation of a continuous aqueous phase solution containing suspension aids (such as dispersants, protective colloids and buffers) followed by mixing with an organic phase comprising dissolved and/or suspended catalyst, the monomer mixture, free-radical initiator and 2 to 5 parts porogen (such as toluene, xylenes, (C₄-C₁₀)-alkanols, (C₆-C₁₂)-saturated hydrocarbons or polyalkylene glycols) per one part monomer. The mixture of monomers and porogen is then polymerized at elevated temperature and the porogen is subsequently removed from the resulting polymer beads by various means; for example, toluene, xylene and (C₄-C₁₀) alcohols may be removed by distillation or solvent washing, and polyalkylene glycols by water washing. The resulting macroporous copolymer is then isolated by conventional means, such as dewatering followed by drying.

Preferred free-radical polymerization initiators include oil-soluble initiators which are dissolved in the monomer, such as benzoyl peroxide, lauroyl peroxide, t-butyl peroctoate, t-butyl peroxy benzoate, t-butyl peroxy pivalate, t-butylperoxy-2-ethylhexanoate, bis (4-t-butyl cyclohexyl) peroxy dicarbonate and the like; and azo compounds such as azo bis (isobutrylonitrile), azo bis (dimethyl valeronitrile) and the like. The polymerization temperature, that is, the temperature at which the suspending medium is held during polymerization of the monomer droplets, and the polymerization initiator are interdependent in that the temperature must be high enough to break the chosen initiator down in to an adequate number of free radicals to initiate and sustain polymerization, that is, it must be above the activation temperature of the initiator. Preferred polymerization temperatures are from about 40° C. to about 100° C., and more preferably from about 50° C. to about 90° C., and the free-radical initiator is chosen so that it has an activation temperature below the polymerization temperature.

Emulsion polymerization is typically carried out in a similar manner, except that the organic phase described above is emulsified within a second continuous phase (usually an aqueous phase). Typically the catalyst is dissolved or dispersed in an oil phase which is emulsified into a continuous aqueous phase to form an emulsion which is generally stabilized by a suitable surfactant system. A wide variety of surfactants suitable for forming and stabilizing such emulsions are commercially available and may be used either as the sole surfactant or in combination. The emulsion may be formed by conventional low or high-shear mixers or homogenization systems, depending on particle size requirements. A wide range of continuous mixing techniques can also be utilized. Suitable mixers which may be employed in particular include dynamic mixers whose mixing elements contain movable pads and static mixers which utilize mixing elements without moving parts in the interior. Combinations of mixers (typically in series) may be advantageous.

Typical examples of suitable surfactants include:
a) condensates of alkyl (e.g. octyl, nonyl or polyaryl) phenols with ethylene oxide and optionally propylene oxide and anionic derivatives thereof such as the corresponding ether sulphates, ether carboxylates and phosphate esters; block copolymers of polyethylene oxide and polypropylene oxide such as the series of surfactants commercially available under the trademark PLURONIC (PLURONIC™ is a trademark of BASF);
b) TWEENTM surfactants, a series of emulsifiers comprising a range of sorbitan esters condensed with various molar proportions of ethylene oxide;
c) condensates of C₈ to C₃₀ alkanols with from 2 to 80 molar proportions of ethylene oxide and optionally propylene oxide; and
d) polyvinyl alcohols, including the carboxylated and sulphonated products.

Once formed, the emulsions may be converted into a microencapsulated catalyst composition employing the free-radical polymerization process described above. Once the droplets have polymerized, the resulting polymer beads may be separated from the suspending medium, dried and cross-linked via sulfone bridges. Processes for such emulsion polymerization are disclosed by U.S. Pat. No. 5,233,096 (Lundquist) as well as in U.S. Pat. No. 8,828,902 (Ramarao et al), the disclosures of which is hereby incorporated by reference.

In certain embodiments, the catalytic compositions are in the form of hollow spheres with the catalyst contained therein. These hollow spheres are particularly useful for the encapsulation of cluster catalysts. Such hollow spheres may be formed by processes similar to those described in U.S. Pat. Nos. 5,229,209, 4,594,363, 4,427,836 or 4,089,800, the descriptions of which are hereby incorporated by reference. One preferred method of manufacturing such hollow shells is that described in U.S. Pat. No. 4,594,363, which process comprises the steps of (A) emulsion polymerization a core from a core monomer system comprised of at least one ethylenically unsaturated monomer containing acid functionality; (B) encapsulating said core with a hard sheath by emulsion polymerizing a sheath monomer system in the presence of said core, said sheath permitting penetration of fixed or permanent bases; and (C) swelling at elevated temperature the resultant core-sheath polymer particles with fixed or permanent base so as to produce a dispersion of particles; modifying such process by using dispersed catalyst or cluster catalyst in place of the seed polymer during the first stage of emulsion polymerization.

In certain embodiments, the catalyst composition of this invention is prepared in the form of a monolith, in which the amount (or weight percentage) of free volume correlates with the amount (or weight percentage) of porogen used. Catalyst, co-monomers, cross-linking agent, pyrogen and one or more organic solvent(s) are combined under high shear mixing. The encapsulated catalyst is placed in a vessel (typical cylindrical or spherical) and heated to remove solvent. In a further embodiment, the solvent also functions as a porogen.

Alternatively, monolith catalyst compositions of this invention may be prepared by combining the co-monomers, cross-linking agent, porogen and one or more organic solvent(s) under high shear mixing to form a mixture; placing the mixture in a vessel (typical cylindrical or spherical) and heating to remove solvent and to produce a macroporous polymer monolith; swelling the macroporous polymer monolith with solvent and adding the transition metal catalyst; and heating a second time to remove solvent thereby forming a macroporous polymer monolith having the catalyst physically entrapped therein.

Depending on the conditions of preparation and in particular the degree of interaction between the catalyst and the wall-forming materials, for example when produced via an emulsion polymerization process, the entrapped catalyst composition of the present invention may be regarded at one extreme as a ‘reservoir’ in which the finely divided catalyst (either as solid or in the presence of residual solvent) is contained within an inner cavity bound by an integral outer polymer shell or at the other extreme as a solid, amorphous polymeric bead throughout which the finely divided catalyst is distributed. Regardless of the physical form of the encapsulated catalyst of the present invention and regardless of the exact mechanism by which access of reactants to the catalyst takes place (diffusion through a permeable polymer shell or absorption into a porous polymeric bead), the catalyst is in a form in which it can be recovered and if desired re-used.

The catalyst compositions of this invention exhibit desirable stability in strong alkaline environments (of pH 10 or higher, pH 11 or higher, pH 12 or higher, or even pH 14 or higher) and are thus well suited to catalyze the decomposition of organic materials (such as nitrosamines) in highly basic compositions (such as nuclear waste). Typically, such a process is a reduction in the presence of hydrogen. As hydrogen is often present in such waste, such a process serves the dual purpose of removing explosive hydrogen as well as of reducing volatile organic compounds which may themselves be radioactive.

The catalyst compositions of this invention additionally possess long term stability, such that when consumed or retired they can be placed into long term storage without concern of degradation and consequential environmental damage.

Further, the catalyst compositions of this invention are regarded as being insoluble in most common organic solvents and consequently can be used in a wide range of organic solvent based reactions. Significantly, such catalytic compositions can be employed to conduct a wide range of coupling reactions. Illustrative of such reactions are the Heck-Mirozoki, Suzuki-Miyaura, Sonogashira-Hagihara, Kumada-Corriu and Negishi reactions/couplings. These couplings are well known to those of skill in the art. As will be recognized by one of skill in the art, the particular reaction conditions for any particular coupling reaction will depend upon the specifics of the reaction itself, including the particular precursors employed, the catalyst selected, etc.

The use of the catalytic compositions of this invention will permit important transitional metals to be used in a sustainable manner, and will afford both economic and environmental benefits.

It is to be understood that each component, compound, substituent, or parameter disclosed herein is to be interpreted as being disclosed for use alone or in combination with one or more of each and every other component, compound, substituent, or parameter disclosed herein.

It is also to be understood that each amount/value or range of amounts/values for each component, compound, substituent, or parameter disclosed herein is to be interpreted as also being disclosed in combination with each amount/value or range of amounts/values disclosed for any other component(s), compounds(s), substituent(s), or parameter(s) disclosed herein and that any combination of amounts/values or ranges of amounts/values for two or more component(s), compounds(s), substituent(s), or parameters disclosed herein are thus also disclosed in combination with each other for the purposes of this description.

It is further understood that each lower limit of each range disclosed herein is to be interpreted as disclosed in combination with each upper limit of each range disclosed herein for the same component, compounds, substituent, or parameter. Thus, a disclosure of two ranges is to be interpreted as a disclosure of four ranges derived by combining each lower limit of each range with each upper limit of each range. A disclosure of three ranges is to be interpreted as a disclosure of nine ranges derived by combining each lower limit of each range with each upper limit of each range, etc. Furthermore, specific amounts/values of a component, compound, substituent, or parameter disclosed in the description or an example is to be interpreted as a disclosure of either a lower or an upper limit of a range and thus can be combined with any other lower or upper limit of a range or specific amount/value for the same component, compound, substituent, or parameter disclosed elsewhere in the application to form a range for that component, compound, substituent, or parameter.

### EXAMPLES

The following Examples are provided to illustrate the invention in accordance with the principles of this invention, but are not to be construed as limiting the invention in any way except as indicated in the appended claims.

### Example 1

Pd encapsulated PS/DVB co-polymer beads

PS/DVB catalyst is prepared according to the following procedure: An aqueous suspending medium is prepared containing 0.55% of Acrysol A-3 polyacrylic acid dispersant, 0.2% sodium hydroxide, 0.39% boric acid, 0.04% gelatin and having a pH of between 8.5 and 8.7. A monomer solution was prepared containing 3.5% commercial 80% divinyl benzene, 95.8% styrene, 0.3% benzoyl peroxide, 0.3% bis (4-t-butylcyclohexyl) peroxydicarbonate and 5.0% of palladium (II) acetate. The monomer mixture is jetted through vibrating jetting orifices 450 microns in diameter, at a rate of 145 kg/hr, into a stream of the suspending medium moving at a rate of 386 liter/hr. This dispersion is conveyed by the flow of suspending medium to a gelling column held at 63° C. The flow produces a residence time of 3.5 hours in the gelling column. The copolymer is separated from the aqueous phase, which is recycled. The copolymer is then held in a finishing kettle for 4 hours a 65° C., then transferred to a final finishing kettle and held at 80° C. for 1.5 hours, heated to 92° C., and held at that temperature for 1 hour. The finished palladium catalyst encapsulated 3.5% divinylbenzene polystyrene copolymer is washed with water and air dried.

The catalyst is evaluated in a Suzuki coupling reaction and is found to have desirable turnover rate and selectivity. An analysis of the catalyst after the reaction shows desirable retention of the palladium within the polymeric matrix.

What is claimed is:

1. A catalyst composition comprising a transition metal catalyst entrapped within a monounsaturated vinyl aromatic/polyunsaturated vinyl aromatic copolymer matrix.

2. The catalyst composition of claim 1 wherein the transition metal catalyst is based upon one or more elements selected from the group consisting of platinum, palladium, osmium, ruthenium, rhodium, iridium, rhenium, scandium, cerium, samarium, yttrium, ytterbium, lutetium, cobalt, titanium, chromium, copper, iron, nickel, manganese, tin, mercury, silver, gold, zinc, vanadium, tungsten and molybdenum.

3. The catalyst composition of claim 3 wherein the transition metal catalyst is based upon palladium.

4. The catalyst composition of claim 1 wherein the polyunsaturated vinylaromatic monomer comprises one or more monomer selected from the group consisting of divinylbenzene, 1,3,5-trivinylbenzene, divinyltoluene, divinylnaphthalene, and divinylxylene.

5. The catalyst composition of claim 4 wherein the polyunsaturated vinylaromatic monomers comprises divinylbenzene.

6. The catalyst composition of claim 1 wherein the monounsaturated vinylaromatic monomer comprises one or more monomer selected from the group consisting of styrene, 60-methylstyrene, (C₁-C₄) alkyl-substituted styrenes and vinylnaphthalene.

7. The catalyst composition of claim 6 wherein the monounsaturated vinylaromatic monomer comprises styrene.

8. The catalyst composition of claim 1 wherein said composition is in the form of a catalyst encapsulated within a monounsaturated vinyl aromatic/polyunsaturated vinyl aromatic copolymer shell.

9. The catalyst composition of claim 1 wherein said composition is in the form of a porous monolithic catalyst.

10. A method of decomposing organic materials contained in nuclear waste materials, which process comprises contacting said organic materials with the catalyst composition of claim 1.

11. A method of catalyzing an organic coupling reaction, which process comprises contacting said organic materials with the catalyst composition of claim 1.

12. The method of claim 11 where the organic coupling reaction is a Heck-Mirozoki, Suzuki-Miyaura, Sonogashira-Hagihara, Kumada-Corriu or Negishi reaction.
